(19) United States
(12) Patent Application Publication
(10) Pub. No.: US 2006/0176269 A1
(43) Pub. Date: Aug. 10, 2006

(54) Activation of electronic paint with registration codes

(75) Inventors: Anthonie H. Bergman, Eindhoven (NL); Hubertus M.R. Cortenraad, Eindhoven (NL); Martin G.H. Hiddink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/565,668

(22) PCT Filed: Jul. 21, 2004
(86) PCT No.: PCT/IB04/51278

§ 371 Date: Jan. 23, 2006

Related U.S. Application Data
(60) Provisional application No. 60/489,628, filed on Jul. 24, 2003.

(51) Int. Cl. G09G 5/00

(52) U.S. Cl. 345/156

(57) ABSTRACT

The invention provides a method of activating an electronic paint (50). An electronic-paint registration code on a coded portion (20) of an electronic paint (50) is scanned. A position of an electronic brush (30) relative to the coded portion (20) of the electronic paint (50) is determined based on the scanned electronic-paint registration code, and a predetermined image is written on the electronic paint (50) based on the position of the electronic brush (30).

This invention relates generally to electronic-paint activation, and more particularly, to a system and method for activating electronic paint with an electronic brush.

The technological and commercial introduction of small electrophoretic displays for personal digital assistants (PDAs), mobile phones, electronic-mail devices, and electronic readers has led to a greater focus on larger electrophoretic displays for whiteboards, signage, billboards and the like, which have been the subject of recent research. Emergent electronic-ink technologies based on electrophoresis enable the writing of a desired image onto a surface containing the electronic ink, also referred to as digital ink. As with many large display applications, a large electrophoretic display may need to be updated only infrequently, with days or even weeks or months between updates.

Electrophoretic displays can be bi-stable, in that their display elements have first and second display states that differ in at least one optical property such as lightness or darkness of a color. In recent electrophoretic displays, the display states occur after microencapsulated particles in the electronic ink have been driven to one state or another by means of an electronic pulse of a finite duration, and the driven state persists after the activation voltage has been removed. Such displays can have attributes of good brightness and contrast, wide-viewing angles, state stability for two or more states, and low power consumption when compared with liquid crystal displays (LCDs).

The surface of an exemplary display comprises a thin electrophoretic film with millions of tiny microcapsules in which positively charged white particles and negatively charged black particles are suspended in a clear fluid. When a negative electric field is applied to the display, the white particles move to the top of the microcapsule where they become visible to the user. This makes the surface appear white at that top position of the microcapsule. At the same time, the electric field pulls the black particles to the bottom of the microcapsules where they are hidden. When the process is reversed, the black particles appear at the top of the microcapsule, which makes the surface appear dark at the top position of the microcapsule. When the voltage is removed, a fixed image remains on the display surface. Before another image is written, the so-called electronic ink of the display material may need to be set to a well-defined state, such as an all white surface with white particles moved to the top of the microcapsules, prior to re-addressing the ink. This can be accomplished by, for example, irradiating the entire display or applying a relatively high voltage to the terminals and electrodes of the display, forcing the ink into one state through the applied electric field.

Current research is moving towards developing commercially viable encapsulated, electrophoretic materials for thin electronic-ink displays that look and feel like pieces of paper. Electronic-ink displays are attractive because they can be more than six times brighter than reflective liquid-crystal displays (LCDs) and can be seen at any angle without a change in contrast, unlike LCDs. Gates and others describe addressing schemes for controlling such bistable electronically addressable displays in “Methods for Addressing Electrophoretic Displays”, Gates, U.S. Pat. No. 6,531,997 issued Mar. 11, 2003.

Researchers are also working on applying this digital- or electronic-ink technology to a large electronic wall display of a so-called electronic-wallpaper, poster or wall screen, which could consist of a thin electrophoretic film placed on a wall. A large electronic-ink display would be appropriate where semi-permanent images are required, such as a large electronic advertisement medium. This electronic low-cost electronic ink application also could be used, for example, for putting a shopping list, the latest vacation pictures, or family pictures on a home wall. The electronic-ink display could also be a standby alternative for other displays such as a polymer-based organic light emitting diode display, which consumes significant power while operating or in a stand-by mode.

Most currently available electrophoretic displays receive data and are addressed by driving an active matrix of the display. Active-matrix driving, however, is not an attractive option for inexpensive billboard-like displays, which require only a low to extremely low refresh rate. Most electronic-ink systems for large electrophoretic displays have no intrinsic addressing schemes, such as fixed coordinates on a pixel-by-pixel grid, to accurately write text and graphics.

Methods, systems and related devices for addressing and writing to electronic-ink displays are still being developed for smaller electrophoretic displays. More attention has been given to transferring input data from the surface of the display to computer usable media, rather than from the computer-usable media to the display surface. Exemplary handheld personal computers, PDAs or web-enabled mobile phones generate data by a user writing and drawing on a touch-sensitive screen of the device, or on a writing tablet with a stylus or other pointing device. Current digital-ink technology can extract information from the handwriting, including the contact pressure, vector, timing, coordinates, and angle of the stylus on the writing surface. One method that provides additional line thickness information is described in “Method of Generating Digital Ink Thickness Information”, U.S. Patent Application, 2002/0163510, Williams et al., Nov. 7, 2002. The method and associated system convert the ballistic movement of a point of a pen over a writing surface into thickness information for digital ink data. The pen includes at least one accelerometer that is used to generate either ballistic movement or ballistic pen tilting information.

An exemplary method for writing onto an active matrix of an electrophoretic display uses a non-conductive brush, as described in “Methods for Addressing Electro-Optic Materials”, Goenaga et al.; U.S. Patent Application 2003/0053189 published Mar. 20, 2003; The method detects a potential difference between the moistened, non-conductive brush and the display. Electrically charged fluid from the pen carries an electronic charge onto the electro-optic material of the display, thereby causing dark particles in the electrophoretic fluid of microscapsules to the top of the microcapsules, which appear as a dark electronic ink contrasted against the light background of the display fluid or light-colored particles.

Systems have been developed to detect the position of and control input devices for electrophoretic as well as other type of displays. Relative positioning systems have been created to detect the motion of a pen on a writing surface, as described in “Electronic Module for Sensing Pen Motion”, U.S. Patent Application 2002/0181744, Vablais et al., Dec. 5, 2002. An electronic module is preferably mounted in a substitute ink cartridge and includes an accelerometer for detecting pen motion. Ballistic information generated by the accelerometer is transmitted via the radio transmitter to a computer where it can be processed for handwriting recognition or digital-ink activation. In another example, a display system has been designed to electronically capture drawings and text written on a standard whiteboard and convert them to computer data. A portable Internet device, which attaches to a standard whiteboard, employs infrared technology to track the position of a marker stylus and eraser on the board.

An electrophoretic display has been employed in an erasable drawing device such as a blackboard, paper pad, or whiteboard, as disclosed in “Microencapsulated Electrophoretic Electrostatically-Addressed Media for Drawing Device Applications”, Comiskey et al., U.S. Pat. No. 6,473,072 issued Oct. 29, 2002. The display includes an encapsulated electrophoretic display media, a rear electrode, and a movable electrode. The encapsulated display media comprises a plurality of capsules, each capsule comprising a plurality of particles dispersed in a fluid. An electric field is applied across the display media with the rear electrode adjacent the rear surface of the display media and across the movable electrode, which can be in the form of a marker or an eraser and is positioned adjacent the frontward surface.

A method for electronically addressing electronic-ink displays is described in “Transducer and Indicators having Printed Displays”, Albert et al., International Patent WO9910769 and U.S. Pat. No. 6,118,426, both granted Sep. 12, 2000. Suggested applications for these displays include small stickers placed on consumer goods like fruit, milk, or batteries, which could be used as freshness indicators by changing the state of the displays after a certain time has elapsed. Other applications include those where it is useful to provide intermittent updates, or when a certain pressure, thermal, radiative, moisture, acoustic, inclination, pH, or other threshold is passed at the position of the display. The display system may use radio frequencies to power, address and control the display, and include one or more antennae, passive charging circuitry, and active control system, a display, and an energy storage unit. A separate transmitter provides remote power for the display. A tile-based display allowing a modular system for large printable area has been suggested with traces disposed on a substrate.

The technological advancements in electrophoretic materials have led to the development of more complex displays. For example, individual display elements can be tiled to create a multi-piece, selectively illuminated, three-dimensional display structures, as described in “Illumination System for Nonemissive Electronic Displays”, Comiskey, WO0020923 published Apr. 13, 2000. The display may be updated using electromagnetic radiation such as visible light.

Addressing systems for smaller electrophoretic displays can be used for larger displays, but there are additional alignment and addressing issues for transferring data such as images or text to a large and variably sized display material, such as on a wall. For example, larger systems that use tiled arrays of displays need to avoid gaps and dead-band regions while retaining constant magnification across adjacent tiles. In other types of wall-display technologies such as light-projection systems, methods of processing, sectionalizing and transferring a large display of data onto a wall have been developed. A large projected display has been created with multiple display devices, a screen, and multiple lens assemblies, as described in “Seamless Tiled Display System”, Dubin et al., U.S. Patent Application 2002/0080302 published Jun. 27, 2002. A scalable seamless tiled display is subdivided into multiple sections, and each section is configured to display a sectional image. One of the lens assemblies is optically coupled to each of the sections of each of the display devices to project the sectional image displayed on that section onto the screen.

While the aforementioned active matrix addressing systems may be feasible for small and big expensive applications, a passive matrix addressing system is desirable for large, inexpensive wall or signage displays. An addressing device for electronic ink needs to be able to write to or locally activate the electronic ink. The addressing device should be able to store the image or text that is being conveyed to the display. The device should be able to determine the location of the device in relation to the display surface.

Transferring data such as a large picture or image to passive electrophoretic material on a wall requires a method for aligning strokes of a handheld device when multiple strokes over the wall are needed. For example, a one-meter by one-meter display may require at least five different strokes of a handheld device that has a 20-centimeter long addressing mechanism, in much the same way that any wall being painted requires multiple strokes with a paint roller. Generating a display with electronic ink requires a process whereby the position of the input device can be determined accurately and multiple strokes over the surface of the electronic ink do not cause alignment artifacts of the device.

Systems in electronic display technologies other than those using electrophoretic materials have been developed to sense or track handheld devices. Exemplary handheld laser scanners can measure three-dimensional surfaces as they move or sweep smoothly near an object and send data to a computer. A computer application converts measurement data into computer generated images, with the finished scan combining overlapping sweeps to develop surface models of non-metal objects.

In light of the discussion above, there is a need for an effective, relatively inexpensive system and electronic output device to control and transfer data to the passive-matrix surface of a large electrophoretic wall display without alignment and problems typically associated with multiple strokes of a device. Therefore, it is the intent of this invention to provide a system, method, and associated electronic input device to control and transfer digital data to an electrophoretic display requiring multiple strokes of the device, electronically generating a picture without alignment artifacts of the device, as well as overcoming the challenges and obstacles described above.

One aspect of the invention is a method of activating an electronic paint. An electronic-paint registration code on a coded portion of an electronic paint is scanned. A position of the electronic brush is determined relative to the coded portion of the electronic paint based on the scanned electronic-paint registration code. A predetermined image is written on the electronic paint based on the determined position of the electronic brush.

Another aspect of the invention is a system for activating an electronic paint. The electronic-paint activation system includes an electronic brush with an electronic-paint activation device, an electronic-brush scanner coupled to the electronic-brush, and a controller in electrical communication with the electronic-paint activation device and the electronic-brush scanner. A position of the electronic brush is determined based on an electronic-paint registration code on a coded portion of an electronic paint that is scanned by the electronic-brush scanner and communicated to the controller. An electronic-paint write signal is sent from the controller to the electronic-paint activation device based on the determined electronic-brush position.

Another aspect of the invention is a system for activating an electronic paint, including means for scanning an electronic-paint registration code on a coded portion of an electronic paint; means for determining a position of an electronic brush relative to the coded portion of the electronic paint based on the scanned electronic-paint registration code; and means for writing a predetermined image in the electronic paint based on the determined positioned of the electronic brush.

Another aspect of the invention is an electronic brush for activating an electronic paint including an electronic-brush housing, an electronic-paint activation device coupled to the electronic-brush housing, an electronic-brush scanner coupled to the electronic-brush housing, and a controller in electrical communication with the electronic-paint activation device and the electronic-brush scanner. A position of the electronic brush is determined based on position signals from the electronic-brush scanner. An electronic-paint write signal is sent from the controller to the electronic-paint activation device based on the determined electronic-brush position.

The aforementioned and other features and advantages of the invention will become further apparent from the following detailed description of the presently preferred embodiments, read in conjunction with the accompanying drawings. The detailed-description and drawings are merely illustrative of the invention rather than limiting, the scope of the invention being defined by the appended claims and equivalents thereof.

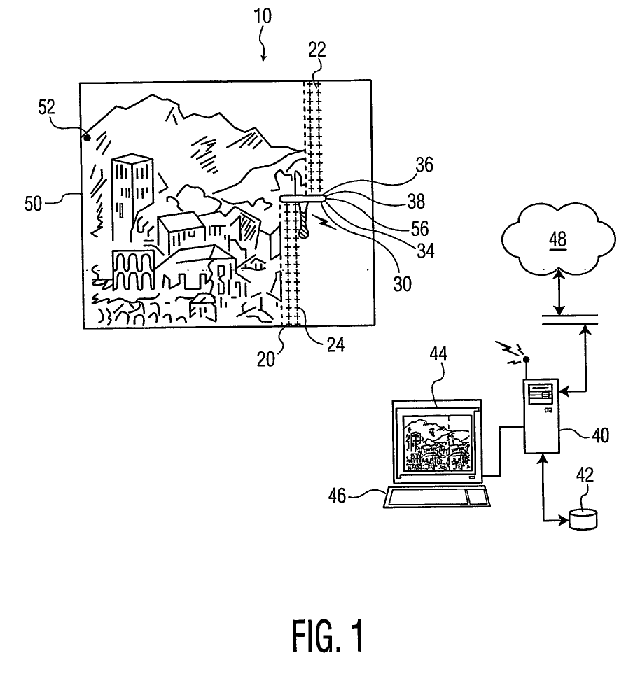

FIG. 1 is an illustration of a system for activating an electronic paint, in accordance with one embodiment of the current invention;

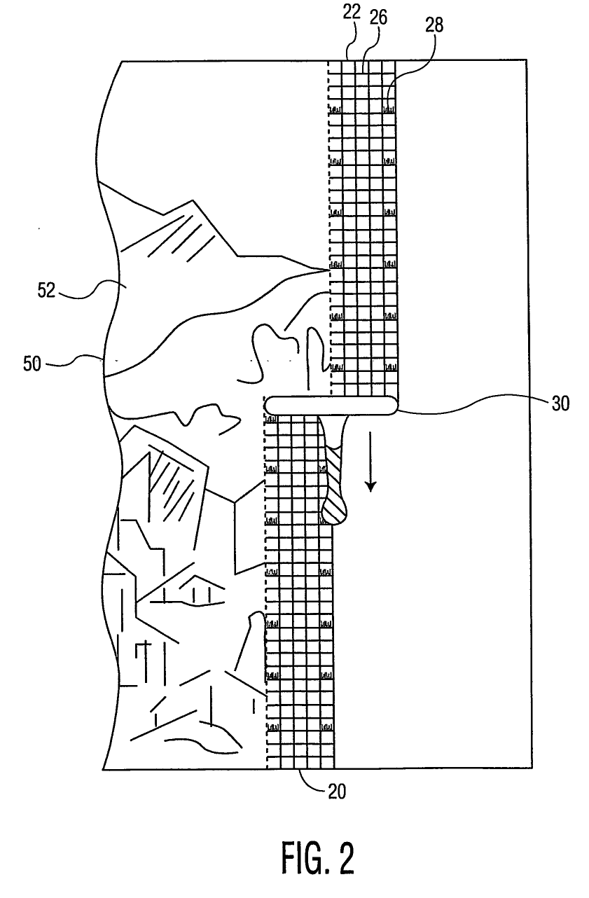

FIG. 2 is an illustration of a system for activating an electronic paint, in accordance with another embodiment of the current invention;

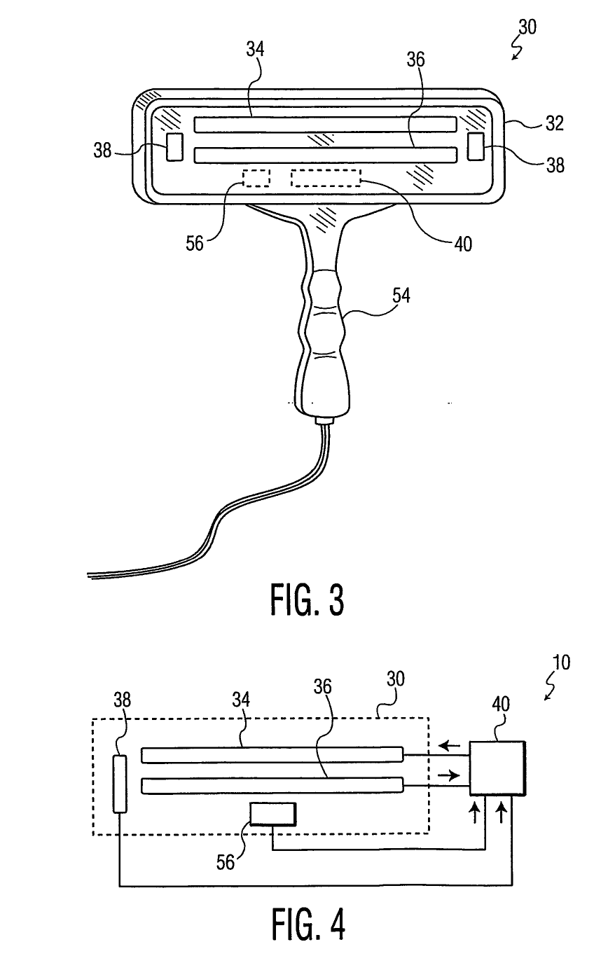

FIG. 3 is an illustration of an electronic brush, in accordance with one embodiment of the current invention;

FIG. 4 is a block diagram of a system for activating an electronic paint, in accordance with one embodiment of the current invention; and

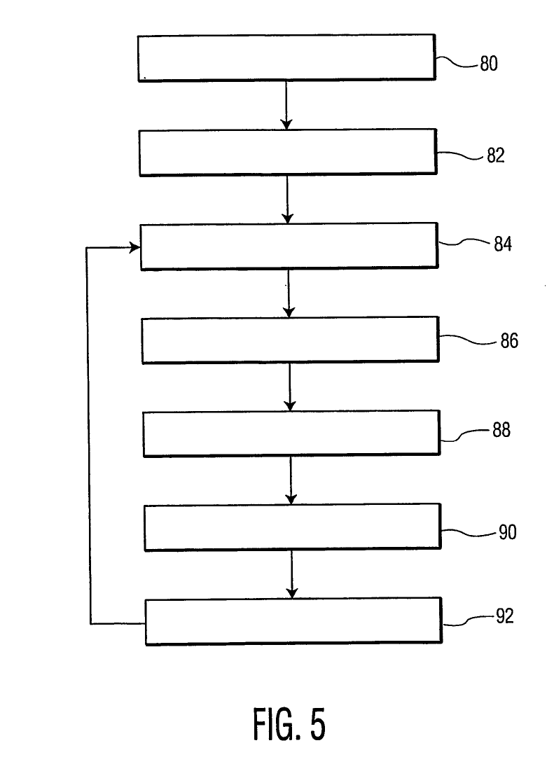

FIG. 5 is a flow diagram of a method for activating an electronic paint, in accordance with one embodiment of the current invention.

FIG. 1 illustrates a system for activating an electronic paint, in accordance with one embodiment of the present invention. Electronic-paint activation system 10 includes an electronic brush 30 with an electronic-paint activation device 34; an electronic-brush scanner 36 coupled to electronic brush 30; and a controller 40 electrically coupled to electronic-paint activation device 34 and electronic-brush scanner 36. Controller 40 may be embedded in or external to electronic brush 30, and wired or wirelessly connected to electronic-paint activation device 34 and electronic-brush scanner 36. When the height or width of an electronic-paint surface 52, for example, electronic wallpaper, is larger than the width of one stroke of electronic brush 30, electronic brush 30 may write an image in or onto electronic paint 50 by activating the electronic paint or ink with multiple strokes of electronic brush 30, each subsequent stroke aligned with the previous stroke.

Coded portions 20 written onto electronic paint 50 on an electronic-paint surface 52 are scanned by electronic-brush scanner 36 and communicated to controller 40. Coded portion 20 of electronic paint 50 includes an electronic-paint registration code such as a set of registration marks 24 that allow a position of electronic brush 30 to be determined. An electronic-paint write signal is sent from controller 40 to electronic-paint activation device 34 based on the electronic-brush position. Though depicted on a wall and serving as electronic wallpaper, electronic-paint surface 52 comprising electronic paint 50 may alternatively be on a desk, table, floor, ceiling, billboard, whiteboard, or other suitable surface.

As electronic brush 30 is stroked or passed over portions of electronic paint 50, a portion of a predetermined image is written onto electronic paint 50. The predetermined image, comprising text, graphics, pictures, or combinations thereof, is written onto electronic paint 50 with electronic-ink or electronic-paint writing processes developed for electrophoretic displays, optically addressed electronic ink, and other types of electronic displays containing electronic ink or paint. As electronic brush 30 is passed multiple times over electronic-paint surface 52, registration marks 24 are detected and analyzed to determine an electronic-brush location and an electronic-brush rotation so that the predetermined image can be written without gaps, waviness, or image shifts. Compensation for rotations and locations of electronic brush 30 are made and updated image information is sent to

electronic-paint activation device 34 for writing onto electronic paint 50 as electronic brush 30 is swept across electronic-paint surface 52. Electronic paint 50 may be reactivated to write the predetermined image over coded portions 20 of electronic paint 50.

An exemplary electronic brush 30, which has a relatively flat, elongated surface area in the shape of a strip or bar, passes over portions of electronic-paint surface 52 to address and activate electronic paint 50. As electronic brush 30 is moved or swept across electronic paint 50, an image including text, drawings, pictures, or combinations thereof, is transferred or written onto electronic paint 50. Electronic paint 50 is addressed by determining an electronic-brush location and writing the intended image at a correct position on electronic-paint surface 52 based on that location determination. The image may be frozen, for example, by removing an activation voltage from across the electronic paint or ink.

When small rotations of electronic brush 30 occur during brush sweeps across electronic paint 50, the result would be excessive waviness and aberrations of the intended image being transferred onto electronic paint 50 if no compensation were given for rotation. Compensation of electronic-brush rotations may be established by, for example, reading two or more registration marks 24 spaced apart on electronic-paint surface 52 and determining measurements of the electronic-brush rotations with respect to those registration marks 24. A determination of electronic-brush rotation can be made as electronic brush 30 is passed over electronic paint 50, and used to compensate for electronic-brush rotations while the intended image is being written. Alternatively, signals from a tilt sensor 56 or other position sensors attached to electronic brush 30 may be used to determine electronic-brush rotation. These signals are of particular use during the first stroke of electronic brush 30 across electronic paint 50.

Data, pixel and address information may be transferred to and stored within electronic brush 30 and then an image can be written onto electronic paint 50 under control of on-board controller 40. Alternatively, a controller 40 such as a personal computer, a laptop computer, a personal digital assistance, a modified cell phone, a wireless device or a digital computing device can be used to store pixel and address information related to electronic paint 50. Controller 40, which may be wired or wirelessly connected to electronic brush 30, can contain the intended image within a database or a memory 42 such as a memory card or stick. Selection and manipulations of the intended image prior to writing onto electronic paint 50 may be made, for example, with the help of computer software and hardware such as a display 44 and an input device 46 like a keyboard or a mouse. Controller 40 may have an Internet or web connection 48 to generate, select or receive image information.

To allow for continued registration and accurate writing onto electronic paint 50, new electronic-paint registration codes such as registration marks 24 may be written onto a previously uncoded portion 22 of electronic paint 50 while writing a portion of the predetermined image on electronic paint 50. In another embodiment, electronic paint 50 has registration codes pre-written onto electronic-paint surface 52, with, for example, fine or faint marks such that the registration codes can be read yet have minimal impact on the quality of the written image.

In some embodiments of the present invention, accurate writing of the codes is particularly critical during the first stroke of electronic brush 30 in order for the location and rotation of electronic brush 30 to be determined accurately during subsequent strokes. One or more position detectors 38 or a tilt sensor 56 may be attached to electronic brush 30 to help determine the position of electronic brush 30 during the first scan. For example, a mechanical position detector 38 such as a wheel, trackball or a set thereof may be coupled to electronic brush 30. More specifically, a set of wheels or trackballs can provide position signals from which an electronic-brush rotation can be determined. In another example, one or more optical position detectors 38, such as those used in an optical mouse for a computer may be coupled to electronic brush 30. Position detectors 38 are in electrical communication with controller 40 to provide an electronic-brush position signal to controller 40 based on a movement of electronic brush 30. Position detectors 38 can provide controller 40 with information on the location, rotation, and in some cases, the travel speed of electronic brush 30, which are used to synchronize the strokes of electronic brush 30 and the writing of the image. Position detectors 38 also provide feedback on the position of electronic brush 30 so that the image can be correctly written, independent of how fast electronic brush 30 is being stroked over electronic-paint surface 52. In another embodiment, a tilt sensor 56 coupled to electronic brush 30 and in electrical communication with controller 40 provides an electronic-brush tilt signal to controller 40 based on rotations of electronic brush 30.

FIG. 2 shows details of a system for activating an electronic paint, in accordance with another embodiment of the current invention. In this depiction, a left side of electronic brush 30 detects registration codes on coded portion 20 of electronic paint 50. As electronic brush 30 is swept in a downward direction, electronic paint 50 on coded portion 20 of electronic paint 50 is reactivated, effectively erasing the registration codes and writing a portion of the predetermined image over the registration codes. While writing a portion of the predetermined image on electronic paint 50, new electronic-paint registration codes are written on uncoded portion 22 of electronic paint 50.

In simplest form, registration marks 24 can take the form of an array of cross hairs as seen in FIG. 1. Other registration marks 24 or codes such as a grid 26 may be written and read to determine the position of electronic brush 30. In cases where electronic brush 30 is lifted or removed from electronic-paint surface 52 and location information for electronic brush 30 is lost or interrupted, an electronic-paint surface coordinate 28 such as numbered coordinates, letters, barcodes, UPC coded numbers, or other suitable surface-location identification and information can be selectively written into electronic paint 50. In one embodiment, registration codes with electronic-paint surface coordinate information are pre-written onto electronic paint 50. The pre-written registration codes may be overwritten or retained for subsequent refreshing or updating of the predetermined image. Registration codes with embedded electronic-paint surface coordinates 28 allow more freedom of movement during multiple passes of electronic brush 30 over electronic-paint surface 52.

FIG. 3 illustrates an electronic brush, in accordance with one embodiment of the present invention. Electronic brush 30 includes an electronic-brush housing 32 with an attached electronic-paint activation device 34, and an attached electronic-brush scanner 36. Controller 40 is electrically coupled to electronic-paint activation device 34 and electronic-brush scanner 36, and may be wired or wirelessly connected to electronic-paint activation device 34 and electronic-brush scanner 36. Electronic brush 30 may include a gripping handle 54 for ease in handling and manipulation.

Electronic-brush scanner 36 includes, for example, a linear or a two-dimensional optical scanner that projects a focused beam of laser light onto an electronic-paint surface to detect registration codes such as a registration mark, a grid, or an electronic-paint surface coordinate. A position of electronic brush 30 is determined based on position signals from electronic-brush scanner 36. Electronic-brush scanner 36 provides position signals when electronic brush 30 is stroked across an electronic-paint surface having a coded portion.

An electronic-paint write signal is sent from controller 40 to electronic-paint activation device 34 based on the electronic-brush position. The write signals convey information to electronic-paint activation device 34 on, for example, the duration, content and intensity of the image data being written. Electronic-paint activation device 34 activates an electronic paint using, for example, a laser scanner that addresses a photoconductor, which is, along with the electronic paint, sandwiched between two conductors. The laser scanner switches the state of the electronic paint or ink by locally changing the conductivity of the photoconductor while a voltage is placed across the conductors.

Electronic brush 30 may include controller 40 in electrical communication with electronic-paint activation device 34 and electronic-brush scanner 36. Controller 40, which may be located within electronic brush 30 or in an external digital computing device operably coupled to electronic brush 30, includes application software and hardware used to determine the location and rotation of electronic brush 30 and to write the corresponding image into the electronic paint. Electronic brush 30 may receive image information through a wired or wireless connection that couples electronic brush 30 to controller 40 when controller 40 is located external to electronic brush 30. The received image information may be stored, for example, within a memory stick or other suitable storage device within electronic brush 30.

A position detector 38 may be included with electronic brush 30 to aid in writing initial registration codes into the electronic paint, and to provide data on the location and rotation of electronic brush 30 to controller 40. One or more position detectors 38 such as wheels, trackballs, optical mice, or a tilt sensor 56 may be coupled to electronic brush 30. Position detectors 38 provide an electronic-brush position signal to controller 40 based on movement of electronic brush 30. For example, a mechanical position detector 38 may include a set of wheels or trackballs at each end of electronic brush 30 that provide signals related to movement of electronic brush 30 from which the position and rotation of electronic brush 30 can be determined. In another example, an optical position detector 38 includes a set of optical mouse devices at each end of electronic brush 30 that provide signals from which the location and rotation of electronic brush 30 can be ascertained. In another example, tilt sensor 56 is coupled to electronic brush 30 from which rotations of electronic brush 30 are determined. Tilt sensor 56 provides an electronic-brush tilt signal to controller 40 based on rotations of electronic brush 30. Tilt signals from tilt sensor 56 can be particularly helpful during the first stroke of electronic brush 30 across the electronic paint, and for following strokes. Electronic brush 30 may have various interfaces, features and accoutrements that affect the quality, affordability, and adaptability of the device. A fully featured and equipped electronic brush 30, for example, may have a larger memory or may be wirelessly connectable to a personal computer and to the Internet.

FIG. 4 shows a block diagram of a system for activating an electronic paint, in accordance with another embodiment of the present invention. Electronic-paint activation system 10 includes an electronic brush 30 for writing a predetermined image on an electronic paint. The predetermined image may be written, for example, with an electronic-paint activation device 34 coupled to electronic brush 30. Writing the predetermined image onto the electronic paint is based on a determination of the position of electronic brush 30. The position of electronic brush 30 may be determined relative to the location of a coded portion of the electronic paint by scanning an electronic-paint registration code on a coded portion of the electronic paint with, for example, a linear or two-dimensional electronic-brush scanner 36. Electronic-paint activation device 34 and electronic-brush scanner 36 are electrically coupled and in communication with controller 40. Controller 40 may be embedded in electronic brush 30 or external to electronic brush 30. Controller 40 may be wired or wirelessly connected to electronic-paint activation device 34 and electronic-brush scanner 36.

A new registration code such as a registration mark, a grid, or an electronic-paint surface coordinate may be written on an uncoded portion of the electronic paint while writing a portion of the predetermined image on another part of the electronic paint. For example, the left half of electronic-paint activation device 34 can write a segment of the predetermined image on a coded portion or uncoded portion of the electronic paint underneath the left side of electronic brush 30, while the right half of electronic-paint activation device 34 writes a new electronic-paint registration code on an uncoded portion of the electronic paint underneath the ride side of electronic brush 30.

An electronic-brush position input may be received from, for example, a mechanical or an optical position detector 38 or from a tilt sensor 56 attached to electronic brush 30 and in electrical communication with controller 40. A new electronic-paint registration code that is based on the electronic-brush position input may be written on an uncoded portion of the electronic paint. For example, when electronic brush 30 is first passed over the electronic-paint surface, a portion of the intended image is written along with an electronic-paint registration code. Subsequent passes of electronic brush 30 over the electronic-paint surface may be synchronized to additional electronic-brush position inputs or to scanned electronic-paint registration codes. When electronic brush 30 is returned to the electronic-paint surface after a temporary removal from the electronic-paint surface, such as after the completion of a stroke, an electronic-paint surface coordinate may be scanned to determine the position of electronic brush 30. After verification of the scanned registration code, the writing of the electronic paint can continue.

FIG. 5 shows a flow diagram of a method for activating an electronic paint, in accordance with one embodiment of the present invention. The electronic-paint activation method includes various steps to determine the position of an electronic brush and to write or activate the electronic paint based on the determination of the brush position.

An electronic-brush position input may be received, as seen at block 80. The electronic-brush position input is received, for example, from a mechanical position detector, an optical position detector, or a tilt sensor coupled to the electronic brush. In some cases there may be no registration codes in the electronic paint when the electronic brush is scanned across the surface of the electronic paint for the first time. Until registration codes can be written in the electronic paint, input signals from one or more position detectors on the electronic brush provide electronic-brush position signals from which the location and rotation of the electronic brush are determined. In other cases, registration codes are pre-written onto the electronic paint, eliminating the need for input from one or more position detectors to determine the position of the electronic brush.

During the first pass of the electronic brush across the surface of the electronic paint, an electronic-paint registration code may be written on an uncoded portion of the electronic paint surface, as seen at block 82. A new electronic-paint registration code is written on an uncoded portion of the electronic paint based on the electronic-brush position input. In embodiments where the registration codes are pre-written in the electronic paint, the position detectors are not required and new registration codes do not need to be written.

An electronic-paint registration code is scanned, as seen at block 84. The electronic-paint registration codes are located on a coded portion of the electronic paint. The electronic-paint registration codes may comprise, for example, a registration mark, a grid, or an electronic-paint surface coordinate. Scanning the registration codes allows a position of the electronic brush to be determined.

The position of the electronic brush is determined based on the scanned electronic-paint registration codes, as seen at block 86. For example, a controller in communication with the electronic brush output analyzes data from the electronic-brush scanner so that the position of the registration marks or codes can be determined. When the positions of the registration marks or codes are determined, the position of the electronic brush relative to the coded portion of the electronic paint can be determined, and the electronic paint can be written to accordingly. The position of the electronic brush may include, for example, location information regarding the physical location of the electronic brush on the electronic-paint surface, and rotation information regarding electronic-brush rotations as the electronic brush is scanned across the electronic-paint surface.

Rotations of the electronic brush, with respect to the surface of the electronic paint as the electronic brush is brushed across the electronic-paint surface, require compensation for writing smooth, non-distorted images onto the electronic paint. An electronic-brush rotation may be determined based on the electronic-paint registration codes. The electronic-brush rotation may be determined, for example, by scanning and reading two registration marks or by inspecting a registration grid.

The physical location of the electronic brush may be determined, for example, by scanning and reading electronic-paint surface coordinates written on the electronic paint. With coordinates such as x and y distances from the fixed reference point of the lower left corner of the electronic-paint surface, the electronic brush can be removed and returned to the electronic-paint surface where the brush is able to determine the electronic-brush location again by reading the coordinates. Electronic-paint surface coordinates may comprise numbered coordinates, letters, barcodes, UPC coded numbers, or other suitable surface-location identification and information formats and indicia.

A predetermined image is written on the electronic paint, as seen at block 88. The predetermined image including text, graphics or pictures is written, for example, with an electronic-paint activation device attached to the electronic brush. The specific portion of the predetermined image that is written is based on the determined position of the electronic brush. The electronic-paint activation device switches the electronic ink or paint from white to black, from black to white, or to a desired color and intensity depending on the type of electronic ink or paint used. Once the electronic paint has been switched, the electronic brush can be moved or removed, and the image is retained by the electronic paint. In some cases, writing the predetermined image on the electronic paint comprises reactivating the electronic paint on the coded portion of the electronic paint, effectively erasing the registration codes and replacing the coded portions with portions of the intended image. Additional strokes of the brush replace and substitute the registration codes with the correct image data and may write new electronic-paint registration codes simultaneously.

As the electronic paint is written with at least a portion of the intended image on a portion of the electronic paint, new electronic-paint registration codes may be written on an uncoded portion of the electronic paint, as seen at block 90. The new electronic-paint registration codes may include, for example, one or more registration marks, grids, or electronic-paint surface coordinates. For example, a left portion of the electronic-paint activation device is sent data associated with the predetermined image, while the right portion of the electronic-paint activation device is sent data associated with the new registration codes. With the next sweep of the brush, the new electronic-paint registration codes are scanned and used to determine the position of the electronic brush so that additional portions of

the predetermined image can be accurately written in the electronic paint. When the image is nearly finished, the writing of new registration codes may be discontinued. In cases where the registration codes are permanently printed on the electronic paint, newly written registration codes may not be needed.

As the first pass and subsequent strokes of the electronic brush are completed and portions of the predetermined image are written, the electronic brush may be removed from and returned to the electronic-paint surface where electronic-paint registration codes are scanned, as seen at block 92. While the electronic brush is moved across the electronic paint, the location and angle of the electronic brush is monitored and updated so that image information can be appropriately addressed and written onto the electronic paint. Steps indicated at block 84 and following are repeated until the entire image is written onto the electronic paint. For larger images, the electronic brush may be passed multiple times in overlapping strokes across the electronic paint to construct a complete picture. After the electronic brush has been removed from the surface area or it has been moved to a new position to begin a new stroke, the painting of the image can continue once the electronic brush is in close proximity to the electronic-paint surface and it has been re-registered to the registration codes. Accurate determination of the electronic brush location and rotation reduces alignment artifacts that can be caused by multiple strokes of the brush.

Finally, the above-discussion is intended to be merely illustrative of the present invention and should not be construed as limiting the appended claims to any particular embodiment or group of embodiments. Each of the systems utilized may also be utilized in conjunction with further systems. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference numerals in the claims are for illustration purposes only and do not limit their protective scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. A method of activating an electronic paint (50), comprising:
scanning an electronic-paint registration code on a coded portion (20) of an electronic paint (50);
determining a position of an electronic brush (30) relative to the coded portion (20) of the electronic paint (50) based on the scanned electronic-paint registration code; and
writing a predetermined image on the electronic paint (50) based on the determined position of the electronic brush (30).

2. The method of claim 1 wherein determining the position of the electronic brush (30) comprises determining an electronic-brush location.

3. The method of claim 1 wherein determining the position of the electronic brush (30) comprises determining an electronic-brush rotation.

4. The method of claim 1 wherein writing the predetermined image on the electronic paint (50) comprises reactivating the electronic paint (50) on the coded portion (20) of the electronic paint (50).

5. The method of claim 1 further comprising:
writing a new electronic-paint registration code on an uncoded portion (22) of the electronic paint (50) while writing a portion of the predetermined image on the electronic paint (50).

6. The method of claim 5 wherein writing the electronic-paint registration code comprises writing one of a registration mark (24), a grid (26), or an electronic-paint surface coordinate (28).

7. The method of claim 1 further comprising:
receiving an electronic-brush position input; and
writing a new electronic-paint registration code on an uncoded portion (22) of the electronic paint (50) based on the electronic-brush position input.

8. The method of claim 7 wherein the electronic-brush position input is received from one of a mechanical position detector (38) or an optical position detector (38).

9. The method of claim 7 wherein the electronic-brush position input is received from a tilt sensor (56) coupled to the electronic brush (30).

10. A system for activating an electronic paint (50), comprising:
an electronic brush (30) including an electronic-paint activation device (34);
an electronic-brush scanner (36) coupled to the electronic brush (30); and
a controller (40) in electrical communication with the electronic-paint activation device (34) and the electronic-brush scanner (36), wherein a position of the electronic brush (30) is determined based on an electronic-paint registration code on a coded portion (20) of an electronic paint (50) that is scanned by the electronic-brush scanner (36) and communicated to the controller (40), and wherein an electronic-paint write signal is sent from the controller (40) to the electronic-paint activation device (34) based on the determined electronic-brush position.

11. The system of claim 10 wherein the electronic-paint registration code comprises one of a registration mark (24), a grid (26), or an electronic-paint surface coordinate (28).

12. The system of claim 10 wherein the controller (40) is embedded in the electronic brush (30).

13. The system of claim 10 wherein the electronic-paint activation device (34) and the electronic-brush scanner (36) are wired or wirelessly connected to the controller (40).

14. The system of claim 10 further comprising:
a mechanical position detector (38) coupled to the electronic brush (30) and in electrical communication with the controller (40), wherein the mechanical position detector (38) provides an electronic-brush position signal to the controller (40) based on a movement of the electronic brush (30).

15. The system of claim 10 further comprising:
an optical position detector (38) coupled to the electronic brush (30) and in electrical communication with the controller (40), wherein the optical position detector (38) provides an electronic-brush position signal to the controller (40) based on a movement of the electronic brush (30).

16. The system of claim 10 further comprising:
a tilt sensor (56) coupled to the electronic brush (30) and in electrical communication with the controller (40), wherein the tilt sensor (56) provides an electronic-brush tilt signal to the controller (40) based on a rotation of the electronic brush (30).

17. A system for activating an electronic paint (50), comprising:
means for scanning an electronic-paint registration code on a coded portion (20) of an electronic paint (50);
means for determining a position of an electronic brush (30) relative to the coded portion (20) of the electronic paint (50) based on the scanned electronic-paint registration code; and
means for writing a predetermined image on the electronic paint (50) based on the determined position of the electronic brush (30).

18. The system of claim 17 further comprising:
means for writing a new electronic-paint registration code on an uncoded portion (22) of the electronic paint (50) while writing a portion of the predetermined image on the electronic paint (50).

19. The system of claim 17 further comprising:
means for receiving an electronic-brush position input; and
means for writing a new electronic-paint registration code on an uncoded portion (22) of the electronic paint (50) based on the electronic-brush position input.

20. An electronic brush (30) for activating an electronic paint (50), comprising:
an electronic-brush housing (32);
an electronic-paint activation device (34) coupled to the electronic-brush housing (32);
an electronic-brush scanner (36) coupled to the electronic-brush housing (32); and
a controller (40) in electrical communication with the electronic-paint activation device (34) and the electronic-brush scanner (36), wherein a position of the electronic brush (30) is determined based on position signals from the electronic-brush scanner (36), and wherein an electronic-paint write signal is sent from the controller (40) to the electronic-paint activation device (34) based on the determined electronic-brush position.

21. The electronic brush (30) of claim 20 wherein the electronic-brush scanner (36) provides the position signals when the electronic brush (30) is stroked across an electronic paint (50) having a coded portion (20).

22. The electronic brush (30) of claim 20 wherein the controller (40) is embedded in the electronic brush (30).

23. The electronic brush (30) of claim 20 wherein the controller (40) is wired or wirelessly connected to the electronic-paint activation device (34) and the electronic-brush scanner (36).

24. The electronic brush (30) of claim 20 further comprising:
a position detector (38) coupled to the electronic brush (30) and in electrical communication with the controller (40), wherein the position detector (38) provides an electronic-brush position signal to the controller (40) based on a movement of the electronic brush (30).

25. The electronic brush (30) of claim 20 further comprising:
a tilt sensor (56) coupled to the electronic brush (30) and in electrical communication with the controller (40), wherein the tilt sensor (56) provides an electronic-brush tilt signal to the controller (40) based on a rotation of the electronic brush (30).
